(19) United States
(12) Patent Application Publication
(10) Pub. No.: US 2021/0040770 A1
(43) Pub. Date: Feb. 11, 2021

(54) ANTI-TORSION DOOR LOCK

(71) Applicant: I-TEK METAL MFG. CO., LTD, Tainan (TW)

(72) Inventor: Chung-Liang Lin, Tainan (TW)

(21) Appl. No.: 16/567,079

(22) Filed: Sep. 11, 2019

(30) Foreign Application Priority Data
Aug. 5, 2019 (TW) 108127784

(51) Int. Cl. E05B 9/08; E05B 15/00

(52) U.S. Cl. CPC E05B 9/08; E05B 15/0053

(57) ABSTRACT

An anti-torsion door lock includes a lock body having an outer chassis. An outer locking plate includes a threaded hole in threading connection with the outer chassis. The outer locking plate further includes two installation holes and at least one coupling hole which are disposed around the threaded hole. Two installation pegs are coupled with the two installation holes and are coupled to a door, preventing rotation of the outer locking plate relative to the door. An anti-torsion member is mounted around the outer chassis and includes at least one lug engaged with the at least one coupling hole of the outer locking plate, such that the anti-torsion member is not pivotable relative to the outer locking plate. The anti-torsion member is non-rotatably mounted to the outer chassis, preventing the lock body from pivoting relative to the door.

### BACKGROUND OF THE INVENTION

The present invention relates to a door lock and, more particularly, to an anti-torsion door lock that is connected to a door to resist a torque generated by turning a handle.

A door lock is mounted to a door and includes a latch movable to an extended position beyond an end face of a door for engaging with an opening in a door frame, retaining the door in a closed position. The latch can be retracted to allow opening of the door. Two handles are generally mounted to inner and outer faces of the door and can be operated to retract the latch through movement of a mechanism in the door lock. When either handle is turned, the lock body creates a torque relative to the door. Thus, when the lock body is installed on the door, a specific structure is required to resist the torque generated by turning the handle, thereby keeping the lock body from rotation. In a typical design, only a side of the lock body is coupled to the door to prevent the lock body from rotating relative to the door. An L-shaped type handle for easy operation by providing a lever arm creates a larger torque more than the case of a handle without a lever arm. As a result, a gap could be created after long term use of the anti-torsion lock body having only one side coupled to the door. The coupling mechanism could be loosened due to the gap, adversely affecting operation of the door lock.

### BRIEF SUMMARY OF THE INVENTION

In an aspect, an anti-torsion door lock according to the present invention includes a lock body including an outer chassis having an outer receiving portion. The outer receiving portion includes an outer periphery having an outer threading and an outer stop portion. A latch is operatively coupled to the lock body and is movable between an extended, latching position and a retracted, latching position. An outer locking plate includes a threaded hole in threading connection with the outer threading of the outer receiving portion. The outer locking plate further includes two installation holes and at least one coupling hole spaced from the two installation holes. The two installation holes and the at least one coupling hole are disposed around the threaded hole. Two installation pegs are coupled with the two installation holes of the outer locking plate and are configured to be received in two anti-torsion holes in a door, preventing rotation of the outer locking plate relative to the door. An anti-torsion member includes a coupling hole having cross sections matched with the outer receiving portion. The coupling hole includes a coupling portion. The anti-torsion member further includes at least one lug on an outer periphery thereof. The anti-torsion member is mounted around the outer receiving portion. The at least one lug engages with the at least one coupling hole, such that the anti-torsion member is not pivotable relative to the outer locking plate. The coupling portion of the anti-torsion member is non-rotatably mounted to the outer stop portion of the lock body, preventing the lock body from pivoting relative to the door.

In an example, the outer locking plate further includes a receiving groove located in a first side of the outer locking plate and having a bottom wall. The at least one coupling hole extends from the bottom wall of the receiving groove through a second side of the outer locking plate opposite to the first side. The anti-torsion member is received in the receiving groove.

In a second aspect, an anti-torsion door lock according to the present invention includes a lock body including an inner chassis and an outer chassis coupled to the inner chassis. The outer chassis includes an outer receiving portion. The outer receiving portion further includes an outer periphery having an outer threading and an outer stop portion. A latch is operatively coupled to the lock body and is movable between an extended, latching position and a retracted, latching position. An inner locking plate is non-rotatably coupled to the inner chassis. An outer locking plate includes a threaded hole in threading connection with the outer threading of the outer receiving portion. The outer locking plate further includes two installation holes and at least one coupling hole spaced from the two installation holes. The two installation holes and the at least one coupling hole are disposed around the threaded hole. Two installation pegs are coupled with the two installation holes of the outer locking plate and are configured to be received in two anti-torsion holes in a door, preventing rotation of the outer locking plate relative to the door. An anti-torsion member includes a coupling hole having cross sections matched with the outer receiving portion. The coupling hole includes a coupling portion. The anti-torsion member further includes at least one lug on an outer periphery thereof. The anti-torsion member is mounted around the outer receiving portion. The at least one lug engages with the at least one coupling hole, such that the anti-torsion member is not pivotable relative to the outer locking plate. The coupling portion of the anti-torsion member is non-rotatably mounted to the outer stop portion of the lock body, preventing the lock body from pivoting relative to the door.

In an example, the outer locking plate further includes a receiving groove located in a first side of the outer locking plate and having a bottom wall. The anti-torsion member is received in the receiving groove. The at least one coupling hole includes two coupling holes. The two installation holes and the two coupling holes extend from the bottom wall of the receiving groove through the second side of the outer locking plate and are disposed around the threaded hole. Each of the two installation holes is disposed between the two coupling holes in a circumferential direction about an axial direction of the threaded hole and has non-circular cross sections. The at least one lug of the at least one anti-torsion member includes two lugs coupled with the two coupling holes of the outer locking plate.

The lock body provides a first anti-torsion effect through coupling of the inner locking plate and the inner chassis and provides a second anti-torsion effect through coupling of the coupling portion of the anti-torsion member and the outer stop portion while the two bugs engage with the two coupling holes of the outer locking plate. Namely, an anti-torsion effect is provided at both sides.

The present invention will become clearer in light of the following detailed description of illustrative embodiments of this invention described in connection with the drawings.

### DESCRIPTION OF THE DRAWINGS

FIG. 1 is an exploded, perspective view of an anti-torsion door lock of an embodiment according to the present invention.

FIG. 2 is a perspective view of the anti-torsion door lock of FIG. 1.

FIG. 3 is a cross sectional view taken along section line 3-3 of FIG. 2.

FIG. 4 is a cross sectional view taken along section line 4-4 of FIG. 3.

FIG. 5 is a cross sectional view taken along section line 5-5 of FIG. 3.

All figures are drawn for ease of explanation of the basic teachings of the present invention only; the extensions of the figures with respect to number, position, relationship, and dimensions of the parts to form the embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “inner”, “outer”, “side”. “end”, “portion”, “section”, “axial”, “circumferential”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

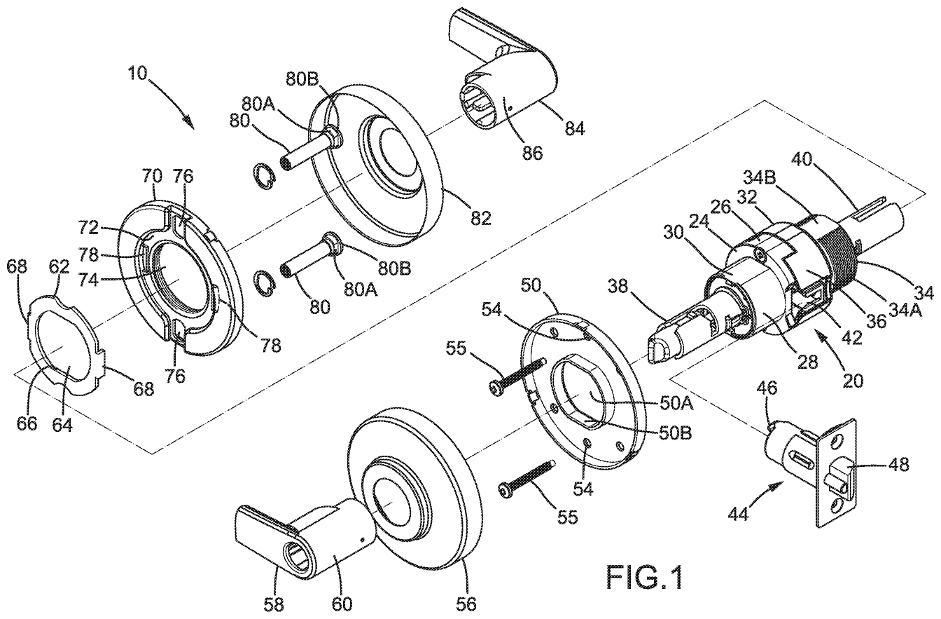

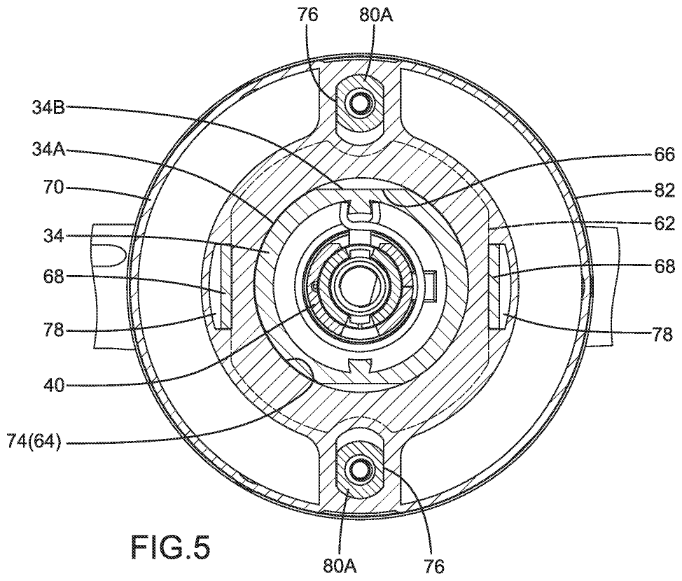

With reference to FIGS. 1-5, an ant-torsion door lock 10 of an embodiment according to the present invention is adapted to be mounted to a door 88 and includes a lock body 20. The lock body 20 includes an inner chassis 24 and an outer chassis 32 coupled to the inner chassis 24. The inner chassis 24 includes an inner coupling portion 26 and an inner receiving portion 28 having a volume smaller than the inner coupling portion 26. The inner receiving portion 28 includes an inner stop portion 30, such that the inner receiving portion 28 has non-circular cross sections. The outer chassis 32 includes an outer coupling portion 36 and an outer receiving portion 34 having a volume smaller than the inner coupling portion 36. The outer receiving portion 34 includes an outer periphery having an outer threading 34A and an outer stop portion 34B, such that the outer receiving portion 34 has non-circular cross sections.

The inner coupling portion 26 of the inner chassis 24 couples with the outer coupling portion 36 of the outer chassis 32. Furthermore, a retractor 42 is movably received in a space between the inner coupling portion 26 and the outer coupling portion 36. Furthermore, a spindle 38 is pivotably mounted to the inner chassis 24 and is jointly movable with the retractor 42. An outer spindle 40 is pivotably mounted to the outer chassis 32 and is jointly movable with the retractor 42. Thus, the retractor 42 displaces when the inner spindle 38 or the outer spindle 40 pivots.

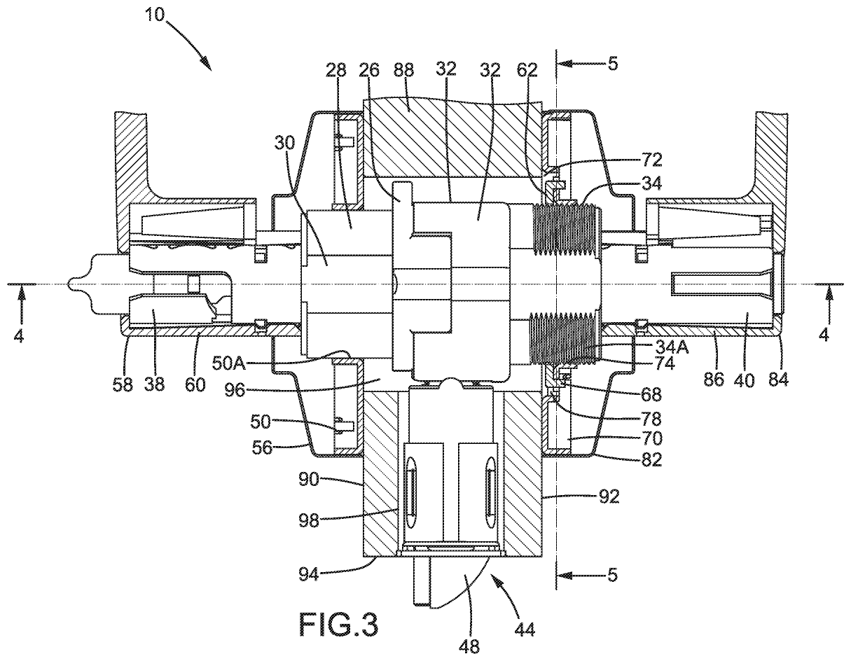

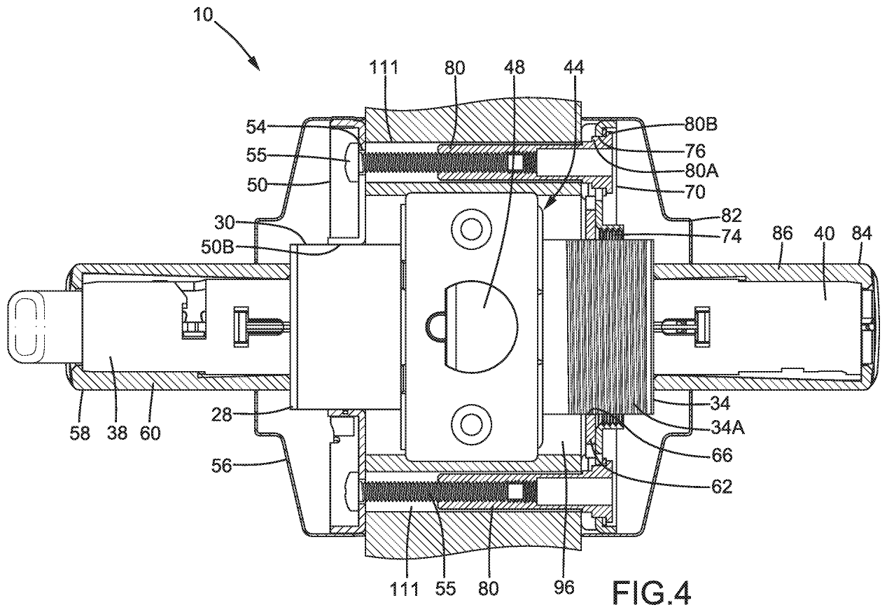

The lock body 20 is coupled to the door 88. The door 88 includes an inner face 90, an outer face 92 opposite to the inner face 90, and an end face 94 extending between the inner face 90 and the outer face 92 (FIG. 3). The door 88 further includes an installation space 96 extending from the inner face 90 through the outer face 92. The door 88 further includes two anti-torsion through-holes 111 located outside of and smaller than the installation hole 96 (FIG. 4). The door 88 further includes a transverse hole 98 extending from the end face 94 to the installation space 96. The lock body 20 is received in the installation space 96. The inner spindle 38 is at an inner side of the door 88. The outer spindle 40 is at an outer side of the door 88. The retractor 42 is substantially aligned with the transverse hole 98.

A latch device 44 is received in the transverse hole 98 of the door 88 and includes an engaging portion 46 jointly movable with the retractor 42 and a latch 48 jointly movable with the engaging portion 46. When the retractor 42 displaces, the latch 48 moves between an extended, latching position and a retracted, unlatching position.

The door lock 10 further includes an inner locking plate 50 coupled with the inner receiving portion 28 and an outer locking plate 70 coupled with the outer receiving portion 34. The inner locking plate 50 includes an inner coupling hole 50A having cross sections matched with the cross sections of the inner receiving portion 28. The inner coupling hole 50A includes an inner coupling portion 50B and, thus, has non-circular cross sections. The inner locking plate 50 further includes two through-holes 54 located outside of the inner coupling hole 50A. The inner locking plate 50 is mounted around the inner receiving portion 28 and abuts against the inner side 90 of the door 88. The inner coupling portion 50B is non-rotatably mounted to the inner stop portion 30. Thus, the inner locking plate 50 cannot rotate relative to the lock body 20. Furthermore, the two through-holes 54 of the inner locking plate 50 are aligned with the two anti-torsion holes 111 of the door 88.

The door lock 10 further includes an anti-torsion member 62 having a coupling hole 64 with cross sections matched with the cross sections of the outer receiving portion 34. The coupling hole 64 includes a coupling portion 66. The anti-torsion member 62 further includes two lugs 68 on an outer periphery thereof. The anti-torsion member 62 is mounted around the outer receiving portion 34. The coupling portion 66 is non-rotatably coupled to the outer stop portion 34B. Thus, the anti-torsion member 62 cannot pivot relative to the lock body 20.

The outer locking plate 70 includes a first side, a second side opposite to the first side, and a receiving groove 72 in the first side. The outer locking plate 70 further includes a threaded hole 74 extending from the first side through the second side of the outer locking plate 70 and having an inner threading. The outer locking plate 70 further includes two installation holes 76 and two coupling holes 78 spaced from the two installation holes 76. The two installation holes 76 and the two coupling holes 78 extend from a bottom wall of the receiving groove 72 through the second side of the outer locking plate 70 and are disposed around the threaded hole 74. Each of the two installation holes 76 is disposed between the two coupling holes 78 in a circumferential direction about an axial direction of the threaded hole 74 and has non-circular cross sections. The outer locking plate 70 is in threading connection with the outer threading 34A of the outer receiving portion 34. The outer locking plate 70 can be rotated to move in an axial direction of the lock body 20 to a position substantially abutting the outer side 92 of the door 88. The two installation holes 76 are aligned with the two anti-torsion holes 111. The anti-torsion member 62 is received in the receiving groove 72 of the outer locking plate 70. The two lugs 68 of the anti-torsion member 62 are coupled with the two coupling holes 78 of the outer locking plate 70, respectively. Thus, the outer locking plate 70 cannot rotate relative to the lock body 20.

The door lock 10 further includes two installation pegs 80 coupled with the outer locking plate 70. Each of the two installation pegs 80 has an inner threading. Each of the two installation pegs 80 includes an end having an assembling portion 80A and an enlarged portion 80B at an end face of the assembling portion 80A. The assembling portion 80A of each of the two installation pegs 80 is non-rotatably coupled with an associated one of the two installation holes 76 of the outer locking plate 70. The enlarged portions 80B of the two installation pegs 80 abuts the second side of the outer locking plate 70. Each enlarged portion 80B has a diameter larger than a diameter of the associated installation hole 76 and, thus, cannot pass through the associated installation hole 76.

With reference to FIG. 4, two screws 55 extend through the two through-holes 54 of the inner locking plate 50 into the two installation pegs 80. When the two screws 55 are tightened to the two installation pegs 80, heads of the two screws 55 abuts against the inner locking plate 50, and the enlarged portions 80B of the two installation pegs 80 abuts against the outer locking plate 70. Thus, the inner locking plate 50 and the outer locking plate 70 are securely attached to the inner face 90 and the outer face 92 of the door 88. Furthermore, the lock body 20 is coupled to the door 88 through the anti-torsion member 62, the outer locking plate 70, the two installation pegs 80, and the inner locking plate 50. Accordingly, the lock body 20 cannot rotate relative to the door 88, permitting rotation of the inner spindle 38 or the outer spindle 40 without rotating the lock body 20.

The door lock 10 further includes an inner escutcheon 56 covering the inner locking plate 50 and an outer escutcheon 82 covering the outer locking plate 70. The door lock 10 further includes an inner handle 58 and an outer handle 84. The inner handle 58 includes a shank 60 extending through the inner escutcheon 56 and coupled to the inner spindle 38 to permit joint movement of the shank 60 and the inner spindle 38. The outer handle 84 includes a shank 86 extending through the outer escutcheon 82 and coupled to the outer spindle 40 to permit joint movement of the shank 86 and the outer spindle 40. Thus, the inner handle 58 can be used to pivot the inner spindle 38 to thereby retract the latch 48 to the retracted, unlatching position. Also, the outer handle 84 can be used to pivot the outer spindle 40 to thereby retract the latch 48 to the retracted, unlatching position.

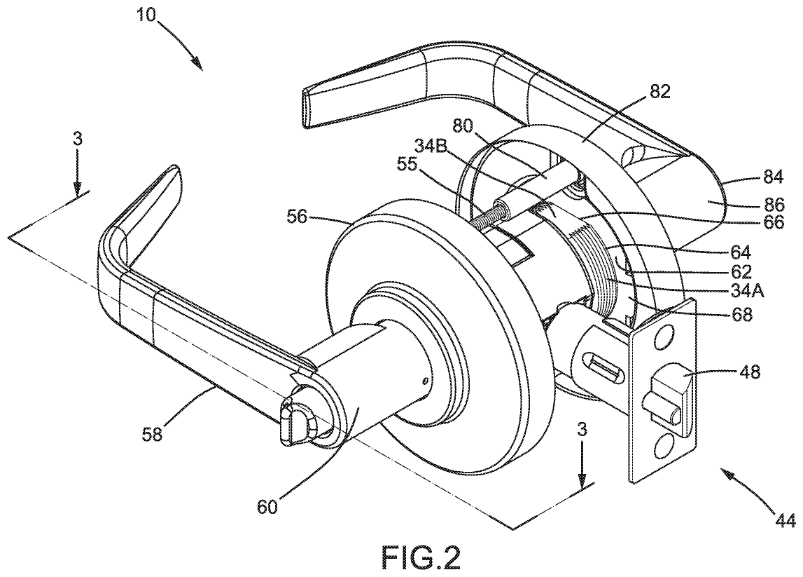

The door lock 10 according to the present invention uses the two installation pegs 80 to couple with the outer locking plate 70 and the door 88. Furthermore, the two screws 55 are used to engage the inner locking plate 50 with the two installation pegs 80. The lock body 20 provides a first anti-torsion effect through coupling of the coupling section 50B of the inner locking plate 50 and the inner stop portion 30 and provides a second anti-torsion effect through coupling of the coupling portion 66 of the anti-torsion member 62 and the outer stop portion 34B while the two bugs 68 engage with the two coupling holes 78 of the outer locking plate 70. Namely, an anti-torsion effect is provided at both sides. Accordingly, even if the inner handle 58 and the outer handle 84 are in the form of L-shaped design with a lever arm (FIG. 2), the lock body 20 is still less likely to rotate relative to the door 88 during rotation of the inner handle 58 or the outer handle 84 for operating the door lock 88, improving the structural strength and durability of the door lock 10.

Now that the basic teachings of the present invention have been explained, many extensions and variations will be obvious to one having ordinary skill in the art. For example, the outer locking plate 70 can include only one coupling hole 78, and the anti-torsion member 62 can include only one lug 68 coupled with the coupling hole 78.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An anti-torsion door lock comprising:
a lock body including an outer chassis having an outer receiving portion, wherein the outer receiving portion includes an outer periphery having an outer threading and an outer stop portion;
a latch operatively coupled to the lock body and movable between an extended, latching position and a retracted, latching position;
an outer locking plate including a threaded hole in threading connection with the outer threading of the outer receiving portion, wherein the outer locking plate further includes two installation holes and at least one coupling hole spaced from the two installation holes, wherein the two installation holes and the at least one coupling hole are disposed around the threaded hole;
two installation pegs coupled with the two installation holes of the outer locking plate and configured to be received in two anti-torsion holes in a door, preventing rotation of the outer locking plate relative to the door;
an anti-torsion member including a coupling hole having cross sections matched with the outer receiving portion, wherein the coupling hole includes a coupling portion, wherein the anti-torsion member further includes at least one lug on an outer periphery thereof, wherein the anti-torsion member is mounted around the outer receiving portion, wherein the at least one lug engages with the at least one coupling hole, such that the anti-torsion member is not pivotable relative to the outer locking plate, and wherein the coupling portion of the anti-torsion member is non-rotatably mounted to the outer stop portion of the lock body, preventing the lock body from pivoting relative to the door.

2. The anti-torsion door lock as claimed in claim 1, wherein the outer locking plate further includes a receiving groove located in a first side of the outer locking plate and having a bottom wall, wherein the at least one coupling hole extends from the bottom wall of the receiving groove through a second side of the outer locking plate opposite to the first side, and wherein the anti-torsion member is received in the receiving groove.

3. An anti-torsion door lock comprising:
a lock body including an inner chassis and an outer chassis coupled to the inner chassis, wherein the outer chassis includes an outer receiving portion, wherein the outer receiving portion further includes an outer periphery having an outer threading and an outer stop portion;
a latch operatively coupled to the lock body and movable between an extended, latching position and a retracted, latching position;
an inner locking plate non-rotatably coupled to the inner chassis;
an outer locking plate including a threaded hole in threading connection with the outer threading of the outer receiving portion, wherein the outer locking plate further includes two installation holes and at least one coupling hole spaced from the two installation holes, wherein the two installation holes and the at least one coupling hole are disposed around the threaded hole;
two installation pegs coupled with the two installation holes of the outer locking plate and configured to be received in two anti-torsion holes in a door, preventing rotation of the outer locking plate relative to the door;
an anti-torsion member including a coupling hole having cross sections matched with the outer receiving portion, wherein the coupling hole includes a coupling portion, wherein the anti-torsion member further includes at least one lug on an outer periphery thereof, wherein the anti-torsion member is mounted around the outer receiving portion, wherein the at least one lug engages with the at least one coupling hole, such that the anti-torsion member is not pivotable relative to the outer locking plate, and wherein the coupling portion of the anti-torsion member is non-rotatably mounted to the outer stop portion of the lock body, preventing the lock body from pivoting relative to the door.

4. The anti-torsion door lock as claimed in claim 3, wherein the outer locking plate further includes a receiving groove located in a first side of the outer locking plate and having a bottom wall, wherein the at least one coupling hole extends from the bottom wall of the receiving groove through a second side of the outer locking plate opposite to the first side, and wherein the anti-torsion member is received in the receiving groove.

5. The anti-torsion door lock as claimed in claim 4, wherein the at least one coupling hole includes two coupling holes, the two installation holes and the two coupling holes extend from the bottom wall of the receiving groove through the second side of the outer locking plate and are disposed around the threaded hole, wherein each of the two installation holes is disposed between the two coupling holes in a circumferential direction about an axial direction of the threaded hole and has non-circular cross sections, and wherein the at least one lug of the at least one anti-torsion member includes two lugs coupled with the two coupling holes of the outer locking plate.
